(19) United States
(12) Patent Application Publication
(10) Pub. No.: US 2026/0269726 A1
(43) Pub. Date: Sep. 10, 2026

(54) POWER SUPPLY CONVERSION CIRCUIT AND POWER SUPPLY CONVERSION DEVICE

(71) Applicant: SUZHOU METABRAIN INTELLIGENT TECHNOLOGY CO., LTD., Suzhou, Jiangsu (CN)

(72) Inventors: Lingyan WANG, Suzhou, Jiangsu (CN); An WU, Suzhou, Jiangsu (CN)

(21) Appl. No.: 18/873,663

(22) PCT Filed: Oct. 9, 2023
(86) PCT No.: PCT/CN2023/123622

§ 371 Date: Dec. 10, 2024

(30) Foreign Application Priority Data
Jan. 9, 2023 (CN) 202310029787.3

(51) Int. Cl. H02M 3/158; H02M 1/00; H02M 1/088; H02M 3/335

(52) U.S. Cl. CPC H02M 3/158; H02M 1/0083; H02M 1/088; H02M 3/33569

(57) ABSTRACT

Provided is a power conversion circuit, including a voltage conversion ratio control unit, a power conversion unit and a first capacitor. One connection end of the first capacitor is connected to a positive voltage terminal of a power supply circuit, the other connection end thereof is connected to a negative voltage terminal of the power supply circuit; a first input connection end of the power conversion unit is connected to one connection end of the first capacitor, and a second input connection end thereof is connected to a first input connection end of the voltage conversion ratio control unit; a second input connection end of the voltage conversion ratio control unit is connected to the other connection end of the first capacitor; and a first output connection end and a second output connection end of the power supply conversion unit are used for supplying power to a load.

### CROSS-REFERENCE TO RELATED APPLICATIONS

This application claims priority to Chinese Patent Application No. 202310029787.3, entitled “POWER CONVERSION CIRCUIT AND POWER CONVERSION DEVICE”, filed on Jan. 9, 2023 to the China National Intellectual Property Administration, the entire contents of which are incorporated herein by reference.

### TECHNICAL FIELD

The present disclosure relates to the technical field of electronic circuits, and in particular, to a power conversion circuit and a power conversion device.

### BACKGROUND

In view of the current industry development trend of high energy consumption and low PUE (Power Usage Effectiveness, a ratio of total data center energy consumption to IT equipment energy consumption) of servers, as the power demand of CPUs, GPUs, etc. increases, the power level required for powering them increases in orders of magnitude in stages. The industry is trending towards adopting a 48V input voltage at the server inlet.

However, the 48V output by the primary power supply in the server is currently converted, by a traditional converter, to different voltages such as 1.8V or 1V required by the motherboard to power CPUs and memory has low conversion efficiency and serious heat generation, and it is difficult to be applied to high-performance application scenarios. However, at present, a traditional converter is adopted to convert the 48V output by the primary power supply in the server to various voltages such as 1.8V or 1V required by the motherboard to power CPUs and memory, resulting in low conversion efficiency and severe heat generation, thus it is difficult to be applied to high-performance application scenarios.

### SUMMARY

An embodiment of the present disclosure provides a power conversion circuit, including: a voltage conversion ratio control unit, a power conversion unit and a first capacitor, the voltage conversion ratio control unit being formed by connecting a few of capacitors and a few of power switching transistors; one connection end of the first capacitor is connected to a positive voltage terminal of a power supply circuit, and the other connection end of the first capacitor is connected to a negative voltage terminal of the power supply circuit; a first input connection end of the power conversion unit is connected to the one connection end of the first capacitor, a second input connection end of the power conversion unit is connected to a first input connection end of the voltage conversion ratio control unit; and a second input connection end of the voltage conversion ratio control unit is connected to the other connection end of the first capacitor; the voltage conversion ratio control unit is configured to change, by controlling the few of power switching transistors to be turned on or off, a connection mode of the few of capacitors, and adjust a voltage value input from the first input connection end and the second input connection end of the voltage conversion ratio control unit, as well as a voltage value input from the first connection end and the second input connection end of the power conversion unit; the power conversion unit includes a first output connection end and a second output connection end, the first output connection end and the second output connection end of the power conversion unit are configured to be connected to a load for supplying power to the load.

In some embodiments, the power conversion unit is a BUCK conversion circuit, a BOOST circuit, or an isolated circuit with a transformer.

In some embodiments, the power conversion unit includes a second capacitor, a third capacitor, a first power switching transistor, a second power switching transistor, and an inductor; one connection end of the second capacitor is connected to the first input connection end of the power conversion unit, and the other connection end of the second capacitor is connected to the second input connection end of the power conversion unit, and the second input connection end of the power conversion unit is connected to the second output connection end of the power conversion unit; a drain of the first power switching transistor is connected to the one connection end of the second capacitor, a source of the first power switching transistor is connected to one connection end of the inductor, and the other connection end of the inductor is connected to the first output connection end of the power conversion unit; a drain of the second power switching transistor is connected to the one connection end of the inductor, and the source of the second power switching transistor is connected to the second input connection end of the power conversion unit; and one connection end of the third capacitor is connected to the first output connection end of the power conversion unit, and the other connection end of the third capacitor is connected to the second output connection end of the power conversion unit.

In some embodiments, when the first power switching transistor is turned on and the second power switching transistor is turned off, the one connection end of the inductor is connected to the first input connection end of the power conversion unit, and the other connection end of the inductor is connected to the first output connection end of the power conversion unit.

In some embodiments, when the first power switching transistor is turned off and the second power switching transistor is turned on, the one connection end of the inductor is connected to the second output connection end of the power conversion unit, and the other connection end of the inductor is connected to the first output connection end of the power conversion unit.

In some embodiments, the power conversion circuit further includes a first switching transistor drive control unit, wherein a gate of the first power switching transistor and a gate of the second power switching transistor are connected to the first switching transistor drive control unit.

In some embodiments, the power conversion circuit further includes a first output voltage sampling unit and a first voltage comparison unit, wherein the first voltage comparison unit is respectively connected to the first output voltage sampling unit and the first switching transistor drive control unit; the first output voltage sampling unit is configured to sample an output voltage output from the first output connection end and the second output connection end of the power conversion unit, and send the output voltage to the first voltage comparison unit; the first voltage comparison unit is configured to compare the output voltage with a reference voltage, and send a comparison result to the first switching transistor drive control unit; the first switching transistor drive control unit is configured to control, based on the comparison result, the first power switching transistor and the second power switching transistor to be turned on or off.

In some embodiments, the first power switching transistor and the second power switching transistor are NMOS transistors; in response to the gates of the first power switching transistor and the second power switching transistor being provided with a high-level signal by the first switching transistor drive control unit, the first power switching transistor and the second power switching transistor are turned on; in response to the gates of the first power switching transistor and the second power switching transistor being provided with a low-level signal by the first switching transistor drive control unit, the first power switching transistor and the second power switching transistor are turned off.

In some embodiments, the first power switching transistor and the second power switching transistor are PMOS transistors; in response to the gates of the first power switching transistor and the second power switching transistor being provided with a low-level signal by the first switching transistor drive control unit, the first power switching transistor and the second power switching transistor are turned on; in response to the gates of the first power switching transistor and the second power switching transistor being provided with a high-level signal by the first switching transistor drive control unit, the first power switching transistor and the second power switching transistor are turned off.

In some embodiments, the few of capacitors include a fourth capacitor, a fifth capacitor, a sixth capacitor, and a seventh capacitor, and the few of power switching transistors include a third power switching transistor, a fourth power switching transistor, a fifth power switching transistor, a sixth power switching transistor, a seventh power switching transistor, and an eighth power switching transistor; one connection end of the fourth capacitor is connected to the first input connection end of the voltage conversion ratio control unit, and the other connection end of the fourth capacitor is connected to the second input connection end of the voltage conversion ratio control unit; a drain of the third power switching transistor is connected to the one connection end of the fourth capacitor, a source of the third power switching transistor is connected to a drain of the fourth power switching transistor, and a source of the fourth power switching transistor is connected to the other connection end of the fourth capacitor; one connection end of the fifth capacitor is connected to the source of the third power switching transistor, the other connection end of the fifth capacitor is connected to a source of the fifth power switching transistor and a drain of the sixth power switching transistor, a drain of the fifth power switching transistor is connected to a first voltage adjustment end of the voltage conversion ratio control unit, and a source of the sixth power switching transistor is connected to a second voltage adjustment end of the voltage conversion ratio control unit; one connection end of the sixth capacitor is connected to the source of the fourth power switching transistor, the other connection end of the sixth capacitor is connected to a source of the seventh power switching transistor and a drain of the eighth power switching transistor, a drain of the seventh power switching transistor is connected to the first voltage adjustment end of the voltage conversion ratio control unit, and a source of the eighth power switching transistor is connected to the second voltage adjustment end of the voltage conversion ratio control unit; one connection end of the seventh capacitor is connected to the first voltage adjustment end of the voltage conversion ratio control unit, and the other connection end of the seventh capacitor is connected to the second voltage adjustment end of the voltage conversion ratio control unit.

In some embodiments, in response to the third power switching transistor, the fifth power switching transistor, and the eighth power switching transistor being turned off, and the fourth power switching transistor, the sixth power switching transistor, and the seventh power switching transistor being turned on, the one connection end of the fifth capacitor is connected to one connection end of the sixth capacitor, the other connection end of the fifth capacitor is connected to the other connection end of the seventh capacitor, and the one connection end of the seventh capacitor is connected to the other connection end of the sixth capacitor.

In some embodiments, in response to the third power switching transistor, the fifth power switching transistor, and the eighth power switching transistor being turned off, and the fourth power switching transistor, the sixth power switching transistor, and the seventh power switching transistor being turned on, the voltage across the seventh capacitor is equal to a sum of the voltage across of the fifth capacitor and the voltage across the sixth capacitor.

In some embodiments, in response to the third power switching transistor, the fifth power switching transistor and the eighth power switching transistor being turned on, and the fourth power switching transistor, the sixth power switching transistor and the seventh power switching transistor being turned off, the one connection end of the fifth capacitor is connected to the first input connection end of the voltage conversion ratio control unit, the other connection end of the fifth capacitor is connected to the one connection end of the seventh capacitor, the other connection end of the seventh capacitor is connected to the other connection end of the sixth capacitor, and the one connection end of the sixth capacitor is connected to the second input connection end of the voltage conversion ratio control unit.

In some embodiments, in response to the third power switching transistor, the fifth power switching transistor and the eighth power switching transistor being turned on, and the fourth power switching transistor, the sixth power switching transistor and the seventh power switching transistor being turned off, the voltage across the fourth capacitor is twice of the voltage across the seventh capacitor.

In some embodiments, the power conversion circuit further includes a second switching transistor drive control unit, wherein the gates of the third power switching transistor, the fourth power switching transistor, the fifth power switching transistor, the sixth power switching transistor, the seventh power switching transistor, and the eighth power switching transistor are all connected to the second switching transistor drive control unit.

In some embodiments, the power conversion circuit further includes a second output voltage sampling unit and a second voltage comparison unit, wherein the second voltage comparison unit is connected to the second output voltage sampling unit and the second switching transistor drive control unit respectively; wherein the second output voltage sampling unit is configured to sample the voltage between the first voltage adjustment end and the second voltage adjustment end of the voltage conversion ratio control unit, and send the voltage to the second voltage comparison unit; the second voltage comparison unit is configured to compare the voltage with a second reference voltage, and send a comparison result to the second switching transistor drive control unit; the second switching transistor drive control unit is configured to control, based on the comparison result, the third power switching transistor, the fourth power switching transistor, the fifth power switching transistor, the sixth power switching transistor, the seventh power switching transistor, and the eighth power switching transistor to be turned on or off.

In some embodiments, the third power switching transistor, the fourth power switching transistor, the fifth power switching transistor, the sixth power switching transistor, the seventh power switching transistor, and the eighth power switching transistor are NMOS transistors; in response to the gates of the third power switching transistor, the fourth power switching transistor, the fifth power switching transistor, the sixth power switching transistor, the seventh power switching transistor, and the eighth power switching transistor being provided with a high-level signal by the second switching transistor drive control unit, the third power switching transistor, the fourth power switching transistor, the fifth power switching transistor, the sixth power switching transistor, the seventh power switching transistor, and the eighth power switching transistor are turned on; in response to the gates of the third power switching transistor, the fourth power switching transistor, the fifth power switching transistor, the sixth power switching transistor, the seventh power switching transistor, and the eighth power switching transistor being provided with a low-level signal by the second switching transistor drive control unit, the third power switching transistor, the fourth power switching transistor, the fifth power switching transistor, the sixth power switching transistor, the seventh power switching transistor, and the eighth power switching transistor are turned off.

In some embodiments, the third power switching transistor, the fourth power switching transistor, the fifth power switching transistor, the sixth power switching transistor, the seventh power switching transistor, and the eighth power switching transistor are PMOS transistors; in response to the gates of the third power switching transistor, the fourth power switching transistor, the fifth power switching transistor, the sixth power switching transistor, the seventh power switching transistor, and the eighth power switching transistor being provided with a low-level signal by the second switching transistor drive control unit, the third power switching transistor, the fourth power switching transistor, the fifth power switching transistor, the sixth power switching transistor, the seventh power switching transistor, and the eighth power switching transistor are turned on; in response to the gates of the third power switching transistor, the fourth power switching transistor, the fifth power switching transistor, the sixth power switching transistor, the seventh power switching transistor, and the eighth power switching transistor being provided with a high-level signal by the second switching transistor drive control unit, the third power switching transistor, the fourth power switching transistor, the fifth power switching transistor, the sixth power switching transistor, the seventh power switching transistor, and the eighth power switching transistor are turned off.

In some embodiments, the third power switching transistor, the fifth power switching transistor, and the eighth power switching transistor are turned on or off simultaneously, and the fourth power switching transistor, the sixth power switching transistor, and the seventh power switching transistor are turned on or off simultaneously.

An embodiment of the present disclosure also provides a power conversion device including any of the power conversion circuits as described above.

### BRIEF DESCRIPTION OF THE DRAWINGS

FIG. 1 is a schematic structural diagram of a power conversion circuit provided by an embodiment of the present disclosure;

FIG. 2 is a schematic diagram illustrating a principle of a power conversion circuit provided by an embodiment of the present disclosure;

FIG. 3 is a schematic diagram illustrating steps of sampling, controlling and driving of a power conversion unit provided by an embodiment of the present disclosure;

FIG. 4 is a first schematic structural diagram under working timings of a voltage conversion ratio control unit provided by an embodiment of the present disclosure;

FIG. 5 is a second schematic structural diagram under working timings of a voltage conversion ratio control unit provided by an embodiment of the present disclosure;

FIG. 6 is a schematic diagram illustrating steps of sampling, controlling and driving of a voltage conversion ratio control unit provided by an embodiment of the present disclosure; and

FIG. 7 is a structural block diagram of a power conversion device provided by an embodiment of the present disclosure.

### DETAILED DESCRIPTION OF THE EMBODIMENTS

To make the aforementioned objectives, features, and advantages of this application more apparent and comprehensible, further detailed explanations of the application are provided below in conjunction with the accompanying drawings and specific embodiments.

In recent years, with the rapid growth of high-performance computing applications such as artificial intelligence, machine learning, and big data mining, the equipment density of data centers has gradually increased, and the demand for data centers has continuously increased, resulting in a rapid growth in energy consumption. Currently, the energy consumption of data centers accounts for 2% of the global electricity consumption. The current technical status is that at the server level, the PSU (PC Power supply unit) steps down the voltage from the UPS (Uninterrupted Power Supply) to 12V, and then the BUCK power supply on the motherboard steps the 12V down to various voltages such as 1.8V or 1V to supply power to the CPU and memory. However, with the increasing power demands of CPUs, GPUs, and the like, the required power levels for their supply are increasing by an order of magnitude in stages. Therefore, the traditional power supply methods are becoming inadequate and face numerous challenges. Firstly, the design and selection of cables, connectors and PCBs in a limited space is difficult; secondly, as the power increases, the input current increases, and the conduction loss of large current increases sharply with the square of the current; thirdly, when the power demand of server CPUs continues to grow, the power supply space allowed on the circuit board is decreasing; fourthly, as the current increases and the frequency increases, di/dt multiplies, electromagnetic radiation deteriorates, and the pollution to adjacent data lines due to signal integrity issues is serious. Therefore, the traditional 12V power supply solution has become inadequate, and the method of directly supplying power to XPU (CPU/GPU/ASIC (Application Specific Integrated Circuit)) from 48V is gradually becoming popular.

According to the current development needs, for supplying power to low-voltage loads such as CPUs and GPUs inside the server, an inevitable problem is that, through what method, the input 48V bus may be efficiently converted to a low target voltage value a with high power density. Main technical methods currently used include the following three methods. The first method is to continue using the current BUCK topology conversion circuit technology. However, due to the large input-to-output voltage conversion ratio in the BUCK topology, the duty cycles for power switching transistors are very low, leading to low conversion efficiency, severe heat generation, and making it unsuitable for high-performance applications. The second method involves the use of an isolated transformer topology, which leverages a designed turns ratio of the transformer to achieve a high input-to-output voltage conversion ratio. However, a high turns ratio may significantly impact parasitic parameters of the transformer, leading to reduced overall conversion efficiency of the converter caused by increased parasitic parameters. Additionally, transformers with a high turn ratio occupy a larger volume, making it difficult to achieve high-power design objectives. Furthermore, the transient response characteristics of isolated topologies are poor, which limits their application in scenarios that require high transient response from the load. The third method is a two-stage topology structure, where the front-stage topology converts the 48V bus voltage into a lower input voltage value, and the rear-stage is a BUCK topology that controls the output target voltage value, thereby achieving a power conversion with a wide range of the input-to-output voltage conversion ratio. However, this topology also has a significant issue, that is, an overall conversion efficiency is equal to a product of the front-stage conversion efficiency and the rear-stage conversion efficiency. The overall conversion efficiency is difficult to be further improved after multiplying the two conversion efficiencies.

In view of the above, embodiments of the present disclosure provide a power conversion circuit and a power conversion device to solve the above problems.

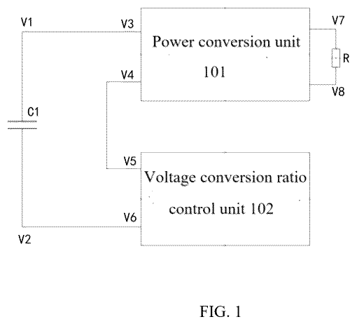

Referring to FIG. 1, a schematic structural diagram of a power conversion circuit provided by an embodiment of the present disclosure is shown. The power conversion circuit includes a voltage conversion ratio control unit 102, a power conversion unit (high power conversion unit) 101 and a first capacitor C1.

A connection end of the first capacitor C1 is connected to a positive voltage terminal V1 of a power supply circuit, and the other connection end of the first capacitor C1 is connected to a negative voltage terminal V2 of the power supply circuit.

A first input connection end V3 of the power conversion unit 101 is connected to one connection end of the first capacitor, a second input connection end V4 of the power conversion unit is connected to a first input connection end V5 of the voltage conversion ratio control unit 102, and a second input connection end V6 of the voltage conversion ratio control unit 102 is connected to the other connection end of the first capacitor. In this way, the unit inputs of the voltage conversion ratio control unit 102 and the power conversion unit 101 are in a series structure, and the outputs thereof are in a parallel structure.

Among them, the power conversion unit 101 includes a first output connection end V7 and a second output connection end V8. The first output connection end V7 and the second output connection end V8 of the power conversion unit 101 are configured to connect a load R to supply power to the load R. That is, the main function of the power conversion unit 101 is to provide required voltage, current and power for the rear-end load R.

The voltage conversion ratio control unit 102 includes several capacitors and several power switching transistors connected. Accordingly, the power switching transistors are controlled to be turned off or turned on to change the connection mode of the capacitors in the voltage conversion ratio control unit 102, thereby adjusting and controlling the voltage input at the first input connection end V5 and the second input connection end V6 of the voltage conversion ratio control unit 102.

The unit inputs of the voltage conversion ratio control unit 102 and the power conversion unit 101 are in a series structure, V1−V2=(V3−V4)+(V5−V6). That is, the voltage input at the first input connection end V3 and the second input connection end V4 of the power conversion unit 101 is adjusted by adjusting and controlling the voltage input at the first input connection end V5 and the second input connection end V6 of the voltage conversion ratio control unit. Therefore, based on actual requirements, the first input connection end V5 and the second input connection end V6 of the voltage conversion ratio control unit 102 may share the voltage input from the power supply circuit for the input connection ends of the power conversion unit 101, thereby reducing a voltage difference between the output voltage (V7−V8) and the input voltage (V3−V4) of the power conversion unit 101, and greatly improving the conversion efficiency of the power conversion circuit.

In the embodiment, a voltage conversion ratio control unit 102 is provided in the power conversion circuit. The unit inputs of the voltage conversion ratio control unit 102 and the power conversion unit 101 are in a series structure. Accordingly, the connection mode of the capacitors in the voltage conversion ratio control unit 102 may be changed by controlling the power switching transistors in the voltage conversion ratio control unit 102 to be turned on or turned off, thereby adjusting the voltage input from the first input connection end V5 and the second input connection end V6 of the voltage conversion ratio control unit 102, and then adjusting the voltage input from the first input connection end V3 and the second input connection end V4 of the power conversion unit 101. In this way, the connection mode of the circuit in the voltage conversion ratio control unit 102 is changed to share the voltage input by the power supply circuit for the input connection ends of the power conversion unit 101, effectively reducing the input voltage value of the power conversion circuit 101, thereby reducing the voltage difference between the output voltage and input voltage of the power conversion unit 101, greatly improving the conversion efficiency of the power conversion unit 101, reducing the heat generation, and making the power conversion circuit suitable for high-performance application scenarios.

On the basis of the above embodiment, a variant embodiment of the above embodiment is proposed. It should be noted that in order to make the description concise, only the differences from the above embodiments are described in the variant embodiments.

In some embodiments, the power conversion unit 101 may be a BUCK circuit (voltage step-down conversion topology), a BOOST circuit (voltage step-up conversion topology), or an isolated circuit with a transformer (isolated topology with a transformer). The power conversion unit 101 may be set according to the target voltage value and working characteristics required by the load R, which is not limited in the embodiments of the present disclosure.

In the above embodiments, the power conversion unit 101 has a high freedom in the selection of topological structures, allowing for selecting different topological structures based on the characteristics of the electrical load R. For instance, when the electrical load R requires good dynamic characteristics and high conversion efficiency, a BUCK conversion topology without isolation may be chosen. When the electrical load R requires characteristics such as an isolation between the input and the output, an isolated topology may be chosen.

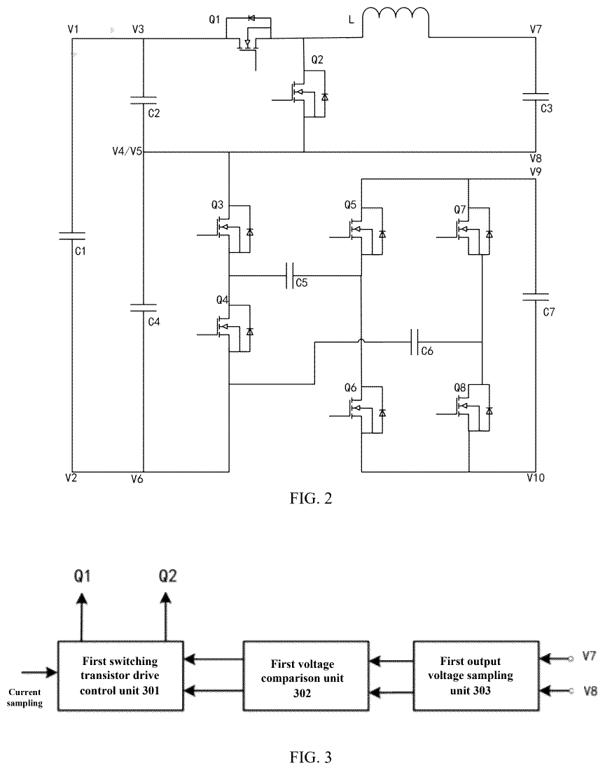

Referring to FIG. 2, a schematic diagram illustrating the principle of the power conversion circuit provided by the embodiments of the present disclosure is shown. When the power conversion unit 101 is a BUCK conversion circuit, the power conversion unit 101 includes a second capacitor C2, a third capacitor C3, a first power switching transistor Q1, a second power switching transistor Q2 and an inductor L.

One connection end of the second capacitor C2 is connected to the first input connection end V3 of the power conversion unit 101, and the other connection end of the second capacitor C2 is connected to the second input connection end V4 of the power conversion unit 101. Moreover, the second input connection end V4 of the power conversion unit 101 is connected to the second output connection end V8 of the power conversion unit 101. That is to say, the second input connection end V4 of the power conversion unit 101 is the second output connection end V8 of the power conversion unit 101.

A drain of the first power switching transistor Q1 is connected to one connection end of the second capacitor C2. A source of the first power switching transistor Q1 is connected to one connection end of the inductor L. The other connection end of the inductor L is connected to the first output connection end V7 of the power conversion unit 101.

A drain of the second power switching transistor Q2 is connected to one connection end of the inductor L. A source of the second power switching transistor Q2 is connected to the second input connection end V4 of the power conversion unit 101.

One connection end of the third capacitor C3 is connected to the first output connection end V7 of the power conversion unit 101. The other connection end of the third capacitor C3 is connected to the second output connection end V8 of the power conversion unit 101.

Specifically, when the first power switching transistor Q1 is turned on and the second power switching transistor Q2 is turned off, one connection end of the inductor L is connected to the first input connection end V3 of the power conversion unit 101, and the other connection end of the inductor L is connected to the first output connection end V7 of the power conversion unit 101. That is to say, in this case, the input power supply of the power conversion unit 101, the first power switching transistor Q1, the inductor L and the load R form a loop. The input power supply of the power conversion unit 101 provides voltage and current for the load R, and the input power supply of the power conversion unit 101 charges the inductor L.

When the first power switching transistor Q1 is turned off and the second power switching transistor Q2 is turned on, one connection end of the inductor L is connected to the second output connection end V8 of the power conversion unit 101, and the other connection end of the inductor L is connected to the first output connection end V7 of the power conversion unit 101. At this time, the inductor L, the second power switching transistor Q2 and the load R form a loop, and voltage and current are supplied to the load R through the inductor L and the third capacitor C3.

Since two power switching transistors are used, a drive circuit is additionally needed to control the power switching transistors as follows.

In some embodiments, the power conversion circuit also includes a first switching transistor drive control unit. The gates of the first power switching transistor Q1 and the second power switching transistor Q2 are connected to the first switching transistor drive control unit. Therefore, the first power switching transistor Q1 and the second power switching transistor Q2 may be controlled to be turned on or off by inputting a high/low level to the gates of the first power switching transistor Q1 and the second power switching transistor Q2 through the first switching transistor drive control unit.

Referring to FIG. 3, a schematic diagram illustrating steps of sampling, controlling and driving of the power conversion unit provided by the embodiments of the present disclosure is shown. The power conversion circuit also includes a first output voltage sampling unit 303 and a first voltage comparison unit 302. The first voltage comparison unit 302 is respectively connected to the first output voltage sampling unit 303 and the first switching transistor drive control unit 301.

The first output voltage sampling unit 303 is connected to the first output connection end V7 and the second output connection end V8 of the power conversion unit 101, so as to sample the output voltage output from the first output connection end V7 and the second output connection end V8 of the power conversion unit 101 and send the output voltage to the first voltage comparison unit 302.

After receiving the output voltage of the power conversion unit 101, the first voltage comparison unit 302 compares the output voltage a reference voltage and send the comparison result to the first switching transistor drive control unit 301.

After receiving the comparison result, the first switching transistor drive control unit 301 may control the first power switching transistor Q1 and the second power switching transistor Q2 to be turned on or off based on the comparison result.

It should be noted that in addition to controlling the first power switching transistor Q1 and the second power switching transistor Q2 to be turned on or off based on the comparison result, the first switching transistor drive control unit 301 may also collect a current signal sample of the power conversion unit 101 as a reference quantity, and control the first power switching transistor Q1 and the second power switching transistor Q2 to be turned on or off based on the current signal and the comparison result, which may be set according to actual needs and will not be limited in the embodiments.

The power switching transistor may be an NMOS transistor or a PMOS transistor. The control methods of the power switching transistor are also different depending on the MOS transistor used. A specific description is given below.

In some embodiments, the first power switching transistor Q1 and the second power switching transistor Q2 are NMOS transistors.

In this case, when the first switching transistor drive control unit 301 inputs a high-level signal to the gates of the first power switching transistor Q1 and the second power switching transistor Q2, the first power switching transistor Q1 and the second power switching transistor Q2 are turned on. When the first switching transistor drive control unit 301 inputs a low-level signal to the gates of the first power switching transistor Q1 and the second power switching transistor Q2, the first power switching transistor Q1 and the second power switching transistor Q2 are turned off.

In some embodiments, the first power switching transistor Q1 and the second power switching transistor Q2 are PMOS transistors.

In this case, when the first switching transistor drive control unit 301 inputs a low-level signal to the gates of the first power switching transistor Q1 and the second power switching transistor Q2, the first power switching transistor Q1 and the second power switching transistor Q2 are turned on. When the first switching transistor drive control unit 301 inputs a high-level signal to the gates of the first power switching transistor Q1 and the second power switching transistor Q2, the first power switching transistor Q1 and the second power switching transistor Q2 are turned off.

Referring to FIG. 2 again, the capacitors in the voltage conversion ratio control unit 102 include a fourth capacitor C4, a fifth capacitor C5, a sixth capacitor C6 and a seventh capacitor C7. The power switching transistors in the voltage conversion ratio control unit 102 include a third power switching transistor Q3, a fourth power switching transistor Q4, a fifth power switching transistor Q5, a sixth power switching transistor Q6, a seventh power switching transistor Q7 and an eighth power switching transistor Q8.

One connection end of the fourth capacitor C4 is connected to the first input connection end V5 of the voltage conversion ratio control unit 102, and the other connection end of the fourth capacitor C4 is connected to the second input connection end V6 of the voltage conversion ratio control unit 102. In this way, the second capacitor C2 and the fourth capacitor C4 are connected in series, and the voltage across the first capacitor C1 is equal to the sum of the voltage across the second capacitor C2 and the voltage across the fourth capacitor C4.

The drain of the third power switching transistor Q3 is connected to one connection end of the fourth capacitor C4. The source of the third power switching transistor Q3 is connected to the drain of the fourth power switching transistor Q4. The source of the fourth power switching transistor Q4 is connected to the other end of the fourth capacitor C4.

One connection end of the fifth capacitor C5 is connected to the source of the third power switching transistor Q3. The other connection end of the fifth capacitor C5 is connected to the source of the fifth power switching transistor Q5 and the drain of the sixth power switching transistor Q6. The drain of the fifth power switching transistor Q5 is connected to a first voltage adjustment end V9 of the voltage conversion ratio control unit 102. The source of the sixth power switching transistor Q6 is connected to a second voltage adjustment end V10 of the voltage conversion ratio control unit 102.

One connection end of the sixth capacitor C6 is connected to the source of the fourth power switching transistor Q4. The other connection end of the sixth capacitor C6 is connected to the source of the seventh power switching transistor Q7 and the drain of the eighth power switching transistor Q8. The drain of the seventh power switching transistor Q7 is connected to the first voltage adjustment end V9 of the voltage conversion ratio control unit 102. The source of the eighth power switching transistor Q8 is connected to the second voltage adjustment end V10 of the voltage conversion ratio control unit 102.

One connection end of the seventh capacitor C7 is connected to the first voltage adjustment end V9 of the voltage conversion ratio control unit 102, and the other connection end of the seventh capacitor C7 is connected to the second voltage adjustment end V10 of the voltage conversion ratio control unit 102.

Among them, the third power switching transistor Q3, the fifth power switching transistor Q5 and the eighth power switching transistor Q8 are turned on or off simultaneously, and the fourth power switching transistor Q4, the sixth power switching transistor Q6 and the seventh power switching transistor Q7 are turned on or off simultaneously.

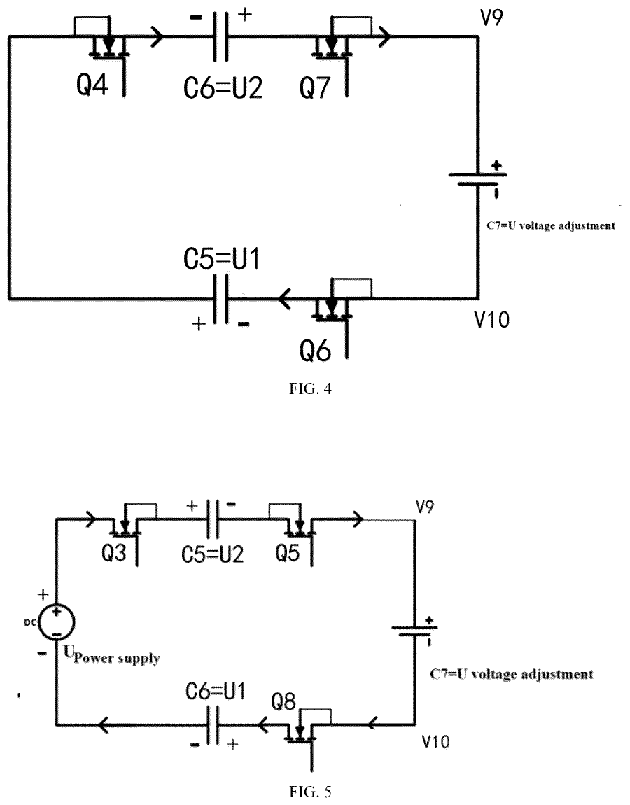

Referring to FIG. 4, a first schematic diagram illustrating working timings of the voltage conversion ratio control unit provided by the embodiments of the present disclosure is shown. When the third power switching transistor Q3, the fifth power switching transistor Q5 and the eighth power switching transistor Q8 are turned off, and the fourth power switching transistor Q4, the sixth power switching transistor Q6 and the seventh power switching transistor Q7 are turned on, one connection end of the fifth capacitor C5 is connected to one connection end of the sixth capacitor C6, the other connection end of the fifth capacitor C5 is connected to one connection end of the seventh capacitor C7, and the other connection end of the seventh capacitor C7 is connected to the other connection end of the sixth capacitor C6. In this case, after the fourth power switching transistor is turned on, the fifth capacitor C5 and the sixth capacitor C6 are connected in series through the fourth power switching transistor to jointly supply energy for the seventh capacitor C7. According to Kirchhoff's voltage law, the voltage across the seventh capacitor C7 is equal to the sum of the voltage across the fifth capacitor C5 and the voltage across the sixth capacitor C6 (U1+U2=U voltage adjustment).

Referring to FIG. 5, a second schematic structural diagram illustrating working timings of the voltage conversion ratio control unit provided by the embodiments is shown. When the third power switching transistor Q3, the fifth power switching transistor Q5 and the eighth power switching transistor Q8 are turned on, and the fourth power switching transistor Q4, the sixth power switching transistor Q6 and the seventh power switching transistor Q7 are turned off, one connection end of the fifth capacitor C5 is connected to the first input connection end V5 of the voltage conversion ratio control unit 102, the other connection end is connected to one connection end of the seventh capacitor C7, the other connection end of the seventh capacitor C7 is connected to one connection end of the sixth capacitor C6, and the other connection end of the sixth capacitor C6 is connected to the second input connection end V6 of the voltage conversion ratio control unit 102. At this time, the voltage value of the fourth capacitor C4 is equal to U power supply, the voltage value of the fifth capacitor C5 is equal to U1, the voltage value of the sixth capacitor C6 is equal to U2, and the voltage value of the seventh capacitor C7 is a target voltage of U voltage adjustment and control, which is equal to the U voltage adjustment. According to Kirchhoff's voltage law, (U power supply=U1+U2+U voltage adjustment) can be obtained. By substituting (U1+U2=U voltage adjustment) into (U power supply=U1+U2+U voltage adjustment), U power supply=2*U voltage adjustment. At this time, the voltage across the fourth capacitor C4 is twice of the voltage across the seventh capacitor C7. Therefore, the voltage value of the fourth capacitor C4 can be clamped by controlling the voltage value across the seventh capacitor C7, and then the input voltage of the power conversion unit 101 can be controlled. The specific control method is described below.

In some embodiments, the power conversion circuit also includes a second switching transistor drive control unit. The gates of the third power switching transistor Q3, the fourth power switching transistor Q4, the fifth power switching transistor Q5, the sixth power switching transistor Q6, the seventh power switching transistor Q7 and the eighth power switching transistor Q8 are all connected to the second switching transistor drive control unit. Therefore, the third power switching transistor Q3, the fourth power switching transistor Q4, the fifth power switching transistor Q5, the sixth power switching transistor Q6, the seventh power switching transistor Q7 and the eighth power switching transistor Q8 may be controlled to be turned on or off by the second switching transistor drive control unit, so as to control the voltage value across the seventh capacitor C7 to clamp the voltage value of the fourth capacitor C4, thereby controlling the input voltage of the power conversion unit 101.

In the above embodiments, the voltage value of the fourth capacitor C4 is clamped within a certain range. The voltage across the fourth capacitor C4 plus the voltage across the second capacitor C2 is equal to the voltage value of the first capacitor C1, which is the input voltage value and a stable voltage value converted by an isolated power converter. The voltage accuracy of the voltage value of the first capacitor C1 is higher than 1%. Therefore, the voltage value of the second capacitor C2 is reduced to the target value, since the voltage value of the first capacitor C1 is stable, the voltage value of the seventh capacitor C7 may be controlled according to the required voltage target value of the second capacitor C2. When the voltage value of the second capacitor C2 is reduced, the voltage conversion ratio of the voltage value of the second capacitor C2 to the voltage value of the third capacitor C3 is reduced. The voltage value of the second capacitor C2 may be controlled according to the input-output voltage conversion ratio required by the optimal efficiency point of the power conversion unit 101.

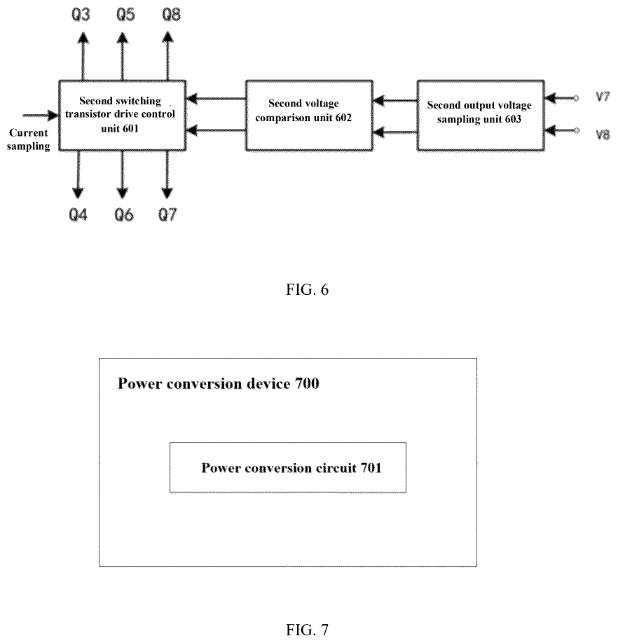

Referring to FIG. 6, a schematic diagram illustrating steps of sampling, controlling and driving of the voltage conversion ratio control unit provided in the embodiments is shown. The power conversion circuit also includes a second output voltage sampling unit 603 and a second voltage comparison unit 602. The second voltage comparison unit 602 is respectively connected to the second output voltage sampling unit 603 and the second switching transistor drive control unit 601.

The second output voltage sampling unit 603 is connected to the first voltage adjustment end V9 and the second voltage adjustment end V10 of the voltage conversion ratio control unit 102. Therefore, the voltage across the first voltage adjustment end V9 and the second voltage adjustment end V10 of the voltage conversion ratio control unit 102 may be collected and sent to the second voltage comparison unit 602.

After receiving the voltage sent by the second output voltage sampling unit 603, the second voltage comparison unit 602 compares the voltage with a second reference voltage and sends the comparison result to the second switching transistor drive control unit 601.

The second switching transistor drive control unit 601 may control the third power switching transistor Q3, the fourth power switching transistor Q4, the fifth power switching transistor Q5, the sixth power switching transistor Q6, the seventh power switching transistor Q7 and the eighth power switching transistor Q8 to be turned on or off based on the comparison result.

It should be noted that in addition to controlling the third power switching transistor Q3, the fourth power switching transistor Q4, the fifth power switching transistor Q5, the sixth power switching transistor Q6, the seventh power switching transistor Q7 and the eighth power switching transistor Q8 to be turned on or off based on the comparison result, the second switching transistor drive control unit 601 may also collect a current signal sample of the voltage conversion ratio control unit 102 as a reference quantity, and control the third power switching transistor Q3, the fourth power switching transistor Q4, the fifth power switching transistor Q5, the sixth power switching transistor Q6, the seventh power switching transistor Q7 and the eighth power switching transistor Q8 to be turned on or off based on the current signal and the comparison result, which may be set according to actual needs and is not limited in the embodiments.

The power switching transistor may be an NMOS transistor or a PMOS transistor. The control methods of the power switching transistors may also be different depending on the MOS transistor used. The control methods are described below.

In some embodiments, the third power switching transistor Q3, the fourth power switching transistor Q4, the fifth power switching transistor Q5, the sixth power switching transistor Q6, the seventh power switching transistor Q7 and the eighth power switching transistor Q8 are NMOS transistors.

In this case, when the second switching transistor drive control unit 601 outputs a high-level signal to the gates of the third power switching transistor Q3, the fourth power switching transistor Q4, the fifth power switching transistor Q5, the sixth power switching transistor Q6, the seventh power switching transistor Q7 and the eighth power switching transistor Q8, the third power switching transistor Q3, the fourth power switching transistor Q4, the fifth power switching transistor Q5, the sixth power switching transistor Q6, the seventh power switching transistor Q7 and the eighth power switching transistor Q8 are turned on. When the second switching transistor drive control unit 601 outputs a low-level signal to the gates of the third power switching transistor Q3, the fourth power switching transistor Q4, the fifth power switching transistor Q5, the sixth power switching transistor Q6, the seventh power switching transistor Q7 and the eighth power switching transistor Q8, the third power switching transistor Q3, the fourth power switching transistor Q4, the fifth power switching transistor Q5, the sixth power switching transistor Q6, the seventh power switching transistor Q7 and the eighth power switching transistor Q8 are turned off.

In some embodiments, the third power switching transistor Q3, the fourth power switching transistor Q4, the fifth power switching transistor Q5, the sixth power switching transistor Q6, the seventh power switching transistor Q7 and the eighth power switching transistor Q8 are PMOS transistors.

When the second switching transistor drive control unit 601 inputs a low-level signal to the gates of the third power switching transistor Q3, the fourth power switching transistor Q4, the fifth power switching transistor Q5, the sixth power switching transistor Q6, the seventh power switching transistor Q7 and the eighth power switching transistor Q8, the third power switching transistor Q3, the fourth power switching transistor Q4, the fifth power switching transistor Q5, the sixth power switching transistor Q6, the seventh power switching transistor Q7 and the eighth power switching transistor Q8 are turned on. When the second switching transistor drive control unit 601 inputs a high-level signal to the gates of the third power switching transistor Q3, the fourth power switching transistor Q4, the fifth power switching transistor Q5, the sixth power switching transistor Q6, the seventh power switching transistor Q7 and the eighth power switching transistor Q8, the third power switching transistor Q3, the fourth power switching transistor Q4, the fifth power switching transistor Q5, the sixth power switching transistor Q6, the seventh power switching transistor Q7 and the eighth power switching transistor Q8 are turned off.

In the aforementioned embodiment, a voltage conversion circuit is proposed, which ensures efficient and high power density conversion of the bus when there is a wide voltage variation in high input bus voltage. The voltage conversion circuit can effectively solve the problems of low power conversion efficiency, large conversion voltage volume, and severe heat generation when large power servers use high input voltage buses such as 48V, and the voltage is converted to various low voltage platform values inside the server, such as 3.3V, 1.8V, 1V, etc.

The proposed power conversion unit 101 circuit has a high freedom degree of selection. Different topology structures are selected according to the characteristics of the electrical load R. When the electrical load R requires good dynamic characteristics and high conversion efficiency, a BUCK conversion topology structure without isolation may be chosen. When the electrical load R requires characteristics such as an isolation between the input and the output, an isolated topology may be chosen.

A circuit of the voltage conversion ratio control unit 102 is proposed, which can adjust the clamping voltage of the input capacitor C4 in the circuit of voltage conversion ratio control unit 102 according to the optimal efficiency operating point of the power conversion unit 101, and then modulate the conversion ratio of the voltage across the input capacitor C2 to the voltage across the output capacitor C3 of the power conversion unit 101.

Compared with the traditional two-stage conversion structure with a conversion ratio of a wide range, the proposed series topology structure has higher conversion efficiency. This is because that the conversion efficiency value of the two-stage conversion is the product of the efficiency values of two conversion topologies, the increase in the number of conversion stages reduces the efficiency.

The proposed voltage conversion ratio control unit 102 is mainly composed of capacitors and power switching transistors without using inductive components. The circuit has high power density, and is easy to be integrated to a chip-level circuit due to the absence of inductive components, which further improves power density and achieves miniaturization design goals. The voltage value of the input capacitor C2 in the power conversion unit 101 is effectively reduced, and the conversion efficiency of the power conversion unit 101 is greatly improved.

Referring to FIG. 7, a structural block diagram of a power conversion device provided by an embodiment of the present disclosure is shown. The power conversion device 700 includes a power conversion circuit 701. The power conversion circuit 701 includes a voltage conversion ratio control unit 102, a power conversion unit 101 and a first capacitor C1. The voltage conversion ratio control unit 102 is formed by several capacitors and several power switching transistors connected together.

One connection end of the first capacitor C1 is connected to the positive voltage terminal of the power supply circuit, and the other connection end of the first capacitor C1 is connected to the negative voltage terminal of the power supply circuit. The first input connection end of the power conversion unit 101 is connected to one connection end of the first capacitor C1, and the second input connection end of the power conversion unit 101 is connected to the first input connection end of the voltage conversion ratio control unit 102. The second input connection end of the voltage conversion ratio control unit 102 is connected to the other connection end of the first capacitor C1.

The voltage conversion ratio control unit is configured to change the connection mode of the capacitors by controlling the power switching transistors to be turned on or off, and adjust the voltage value input from the first input connection end V5 and the second input connection end V6 of the voltage conversion ratio control unit 102 as well as the voltage value input from the first input connection end V3 and the second input connection end V4 of the power conversion unit 101.

The power conversion unit 101 includes the first output connection end and the second output connection end. The first output connection end and the second output connection end of the power conversion unit 101 are used for connecting with a load R to supply power to the load R.

In some embodiments, the power conversion unit 101 is a BUCK conversion circuit, a BOOST circuit or an isolated circuit with a transformer.

In some embodiments, the power conversion unit 101 includes a second capacitor C2, a third capacitor C3, a first power switching transistor Q1, a second power switching transistor Q2 and an inductor L.

One connection end of the second capacitor C2 is connected to the first input connection end of the power conversion unit 101, and the other connection end of the second capacitor C2 is connected to the second input connection end of the power conversion unit 101. The second input connection end of the power conversion unit 101 is connected to the second output connection end of the power conversion unit 101.

The drain of the first power switching transistor Q1 is connected to one connection end of the second capacitor C2. The source of the first power switching transistor Q1 is connected to one connection end of the inductor L. The other connection end of the inductor L is connected to the first output connection end of the power conversion unit 101.

The drain of the second power switching transistor Q2 is connected to one connection end of the inductor L, and the source of the second power switching transistor Q2 is connected to the second input connection end of the power conversion unit 101.

One connection end of the third capacitor C3 is connected to the first output connection end of the power conversion unit 101, and the other connection end of the third capacitor C3 is connected to the second output connection end of the power conversion unit 101.

In some embodiments, when the first power switching transistor Q1 is turned on and the second power switching transistor Q2 is turned off, one connection end of the inductor L is connected to the first input connection end of the power conversion unit 101, and the other connection end of the inductor L is connected to the first output connection end of the power conversion unit 101.

In some embodiments, when the first power switching transistor Q1 is turned off and the second power switching transistor Q2 is turned on, one connection end of the inductor L is connected to the second output connection end of the power conversion unit 101, and the other connection end of the inductor L is connected to the first output connection end of the power conversion unit 101.

In some embodiments, the power conversion circuit also includes a first switching transistor drive control unit. The gates of the first power switching transistor Q1 and the second power switching transistor Q2 are connected to the first switching transistor drive control unit.

In some embodiments, the power conversion circuit also includes a first output voltage sampling unit and a first voltage comparison unit. The first voltage comparison unit is respectively connected to the first output voltage sampling unit and the first switching transistor drive control unit.

The first output voltage sampling unit is configured to sample the output voltage output from the first output connection end and the second output connection end of the power conversion unit 101, and send the output voltage to the first voltage comparison unit.

The first voltage comparison unit is configured to compare the output voltage with a reference voltage, and send the comparison result to the first switching transistor drive control unit.

The first switching transistor drive control unit is configured to control the first power switching transistor Q1 and the second power switching transistor Q2 to be turned on or off based on the comparison result.

In some embodiments, the first power switching transistor Q1 and the second power switching transistor Q2 are NMOS transistors.

When the first switching transistor drive control unit inputs a high-level signal to the gates of the first power switching transistor Q1 and the second power switching transistor Q2, the first power switching transistor Q1 and the second power switching transistor Q2 are turned on.

When the first switching transistor drive control unit inputs a low-level signal to the gates of the first power switching transistor Q1 and the second power switching transistor Q2, the first power switching transistor Q1 and the second power switching transistor Q2 are turned off.

In some embodiments, the first power switching transistor Q1 and the second power switching transistor Q2 are PMOS transistors.

When the first switching transistor drive control unit inputs a low-level signal to the gates of the first power switching transistor Q1 and the second power switching transistor Q2, the first power switching transistor Q1 and the second power switching transistor Q2 are turned on.

When the first switching transistor drive control unit inputs a high-level signal to the gates of the first power switching transistor Q1 and the second power switching transistor Q2, the first power switching transistor Q1 and the second power switching transistor Q2 are turned off.

In some embodiments, the capacitors include a fourth capacitor C4, a fifth capacitor C5, a sixth capacitor C6 and a seventh capacitor C7, and the power switching transistors include a third power switching transistor Q3, a fourth power switching transistor Q4, a fifth power switching transistor Q5, a sixth power switching transistor Q6, a seventh power switching transistor Q7 and an eighth power switching transistor Q8.

One connection end of the fourth capacitor C4 is connected to the first input connection end of the voltage conversion ratio control unit 102, and the other connection end of the fourth capacitor C4 is connected to the second input connection end of the voltage conversion ratio control unit 102.

The drain of the third power switching transistor Q3 is connected to one connection end of the fourth capacitor C4. The source of the third power switching transistor Q3 is connected to the drain of the fourth power switching transistor Q4. The source of the fourth power switching transistor Q4 is connected to the other end of the fourth capacitor C4.

One connection end of the fifth capacitor C5 is connected to the source of the third power switching transistor Q3. The other connection end of the fifth capacitor C5 is connected to the source of the fifth power switching transistor Q5 and the drain of the sixth power switching transistor Q6. The drain of the fifth power switching transistor Q5 is connected to a first voltage adjustment end of the voltage conversion ratio control unit 102. The source of the sixth power switching transistor Q6 is connected to a second voltage adjustment end of the voltage conversion ratio control unit 102.

One connection end of the sixth capacitor C6 is connected to the source of the fourth power switching transistor Q4. The other connection end of the sixth capacitor C6 is connected to the source of the seventh power switching transistor Q7 and the drain of the eighth power switching transistor Q8. The drain of the seventh power switching transistor Q7 is connected to the first voltage adjustment end of the voltage conversion ratio control unit 102. The source of the eighth power switching transistor Q8 is connected to the second voltage adjustment end of the voltage conversion ratio control unit 102.

One connection end of the seventh capacitor C7 is connected to the first voltage adjustment end of the voltage conversion ratio control unit 102, and the other connection end of the seventh capacitor C7 is connected to the second voltage adjustment end of the voltage conversion ratio control unit 102.

In some embodiments, when the third power switching transistor Q3, the fifth power switching transistor Q5 and the eighth power switching transistor Q8 are turned off, and the fourth power switching transistor Q4, the sixth power switching transistor Q6 and the seventh power switching transistor Q7 are turned on, one connection end of the fifth capacitor C5 is connected to one connection end of the sixth capacitor C6, the other connection end of the fifth capacitor C5 is connected to one connection end of the seventh capacitor C7, and the other connection end of the seventh capacitor C7 is connected to the other connection end of the sixth capacitor C6.

In some embodiments, when the third power switching transistor Q3, the fifth power switching transistor Q5 and the eighth power switching transistor Q8 are turned off, and the fourth power switching transistor Q4, the sixth power switching transistor Q6 and the seventh power switching transistor Q7 are turned on, the voltage across the seventh capacitor C7 is equal to the sum of the voltage across the fifth capacitor C5 and the voltage across the sixth capacitor C6.

In some embodiments, when the third power switching transistor Q3, the fifth power switching transistor Q5 and the eighth power switching transistor Q8 are turned on, and the fourth power switching transistor Q4, the sixth power switching transistor Q6 and the seventh power switching transistor Q7 are turned off, one connection end of the fifth capacitor C5 is connected to the first input connection end of the voltage conversion ratio control unit 102, the other connection end of the fifth capacitor C5 is connected to one connection end of the seventh capacitor C7. The other connection end of the seventh capacitor C7 is connected to one connection end of the sixth capacitor C6. The other connection end of the sixth capacitor C6 is connected to the second input connection end of the voltage conversion ratio control unit 102.

In some embodiments, when the third power switching transistor Q3, the fifth power switching transistor Q5 and the eighth power switching transistor Q8 are turned on, and the fourth power switching transistor Q4, the sixth power switching transistor Q6 and the seventh power switching transistor Q7 are turned off, the voltage across the fourth capacitor C4 is twice of the voltage across the seventh capacitor C7.

In some embodiments, the power conversion circuit also includes a second switching transistor drive control unit. The gates of the third power switching transistor Q3, the fourth power switching transistor Q4, the fifth power switching transistor Q5, the sixth power switching transistor Q6, the seventh power switching transistor Q7 and the eighth power switching transistor Q8 are all connected to the second switching transistor drive control unit.

In some embodiments, the power conversion circuit also includes a second output voltage sampling unit and a second voltage comparison unit. The second voltage comparison unit is respectively connected to the second output voltage sampling unit and the second switching transistor drive control unit.

The second output voltage sampling unit is configured to sample the voltage across the first voltage adjustment end and the second voltage adjustment end of the voltage conversion ratio control unit 102, and send the voltage to the second voltage comparison unit.

The second voltage comparison unit is configured to compare the voltage with a second reference voltage, and send the comparison result to the second switching transistor drive control unit.

The second switching transistor drive control unit is configured to control the third power switching transistor Q3, the fourth power switching transistor Q4, the fifth power switching transistor Q5, the sixth power switching transistor Q6, the seventh power switching transistor Q7 and the eighth power switching transistor Q8 to be turned on or off based on the comparison result.

In some embodiments, the third power switching transistor Q3, the fourth power switching transistor Q4, the fifth power switching transistor Q5, the sixth power switching transistor Q6, the seventh power switching transistor Q7 and the eighth power switching transistor Q8 are NMOS transistors.

When the second switching transistor drive control unit outputs a high-level signal to the gates of the third power switching transistor Q3, the fourth power switching transistor Q4, the fifth power switching transistor Q5, the sixth power switching transistor Q6, the seventh power switching transistor Q7 and the eighth power switching transistor Q8, the third power switching transistor Q3, the fourth power switching transistor Q4, the fifth power switching transistor Q5, the sixth power switching transistor Q6, the seventh power switching transistor Q7 and the eighth power switching transistor Q8 are turned on.

When the second switching transistor drive control unit outputs a low-level signal to the gates of the third power switching transistor Q3, the fourth power switching transistor Q4, the fifth power switching transistor Q5, the sixth power switching transistor Q6, the seventh power switching transistor Q7 and the eighth power switching transistor Q8, the third power switching transistor Q3, the fourth power switching transistor Q4, the fifth power switching transistor Q5, the sixth power switching transistor Q6, the seventh power switching transistor Q7 and the eighth power switching transistor Q8 are turned off.

In some embodiments, the third power switching transistor Q3, the fourth power switching transistor Q4, the fifth power switching transistor Q5, the sixth power switching transistor Q6, the seventh power switching transistor Q7 and the eighth power switching transistor Q8 are PMOS transistors.

When the second switching transistor drive control unit inputs a low-level signal to the gates of the third power switching transistor Q3, the fourth power switching transistor Q4, the fifth power switching transistor Q5, the sixth power switching transistor Q6, the seventh power switching transistor Q7 and the eighth power switching transistor Q8, the third power switching transistor Q3, the fourth power switching transistor Q4, the fifth power switching transistor Q5, the sixth power switching transistor Q6, the seventh power switching transistor Q7 and the eighth power switching transistor Q8 are turned on.

When the second switching transistor drive control unit inputs a high-level signal to the gates of the third power switching transistor Q3, the fourth power switching transistor Q4, the fifth power switching transistor Q5, the sixth power switching transistor Q6, the seventh power switching transistor Q7 and the eighth power switching transistor Q8, the third power switching transistor Q3, the fourth power switching transistor Q4, the fifth power switching transistor Q5, the sixth power switching transistor Q6, the seventh power switching transistor Q7 and the eighth power switching transistor Q8 are turned off.

In some embodiments, the third power switching transistor Q3, the fifth power switching transistor Q5 and the eighth power switching transistor Q8 are turned on or off simultaneously, and the fourth power switching transistor Q4, the sixth power switching transistor Q6 and the seventh power switching transistor Q7 are turned on or off simultaneously.

For the device embodiments, since they are basically similar to the circuit embodiments, the description is relatively simple. For relevant parts, please refer to the partial descriptions of the circuit embodiments.

It should be noted that the terms “include”, “comprise” or any other variations thereof used herein are intended to encompass non-exclusive inclusion, such that a process, method, item, or apparatus that includes a series of elements includes not only those elements but also other elements that are not explicitly listed, or elements that are inherent to such a process, method, item, or apparatus. Unless otherwise restricted, the elements defined by the phrase “including a . . . ” do not exclude the presence of additional identical elements in the process, method, item, or apparatus including such an element.

Through the description of the embodiments above, those skilled in the art will clearly understand that the aforementioned method can be implemented using software plus a necessary general-purpose hardware platform, or it can be implemented in hardware. However, in many cases, the former is better. Based on such understanding, the essence of the technical solution of the application, or the part that contributes to the existing technology, can be embodied in the form of a software product, which is stored in a non-volatile readable storage medium (such as ROM/RAM, magnetic disk, optical disk), including several instructions for enabling a terminal (which may be a mobile phone, computer, resource server, air conditioner, or network device, etc.) to execute the methods of the various embodiments of this application.

The embodiments of this application have been described in conjunction with the accompanying drawings. However, the application is not limited to the specific embodiments described above. The specific embodiments are illustrative and not restrictive, and those skilled in the art may make many forms as taught by this application, without departing from the spirit and protection scope of the claims of this application, and all these forms are fallen within the pretention scope of this application.

Those skilled in the art will realize that, the various example units and algorithm steps described in conjunction with the embodiments of the present disclosure may be implemented in electronic hardware, or a combination of computer software and electronic hardware. Whether these functions are executed in hardware or software depends on the specific application and design constraints of the technical solution. Those skilled in the art may use different methods for each specific application to implement the described functions, and such implementation should not be considered beyond the scope of this application.

Those skilled in the art will clearly understand that, for the convenience and brevity of description, the specific working processes of the systems, devices, and units described above may refer to the corresponding processes in the aforementioned method embodiments, which are not repeated here.

In the embodiments provided in the disclosure, it should be understood that the disclosed devices and methods may be implemented in other ways. For example, the device embodiments described above are merely illustrative, such as the division of units, which is only a logical functional division. In actual implementation, there can be other division methods, such as multiple units or components can be combined or integrated into another system, or some features can be ignored, or not executed. Additionally, the coupling or direct coupling or communication connections shown or discussed between each other can be indirect coupling or communication connections through some interfaces, devices, or units, and can be in the form of electrical, mechanical, or other forms.

Units described as separate parts can be or not be physically separated, and components displayed as units can be or not be physical units, that is, they can be located in one place or distributed across multiple network units. Depending on actual needs, some or all of the units can be selected to achieve the purpose of this embodiment.

Additionally, various functional units in the embodiments of the disclosure can be integrated into one processing unit, or they can exist separately physically, or two or more units can be integrated into one unit.

If the functions are implemented in the form of software functional units and sold or used as independent products, they can be stored in a computer-readable non-volatile readable storage medium. Based on this understanding, the technical solution of this application, or the part that contributes to the existing technology, or part of the technical solution, can be embodied in the form of a software product, which is stored in a non-volatile readable storage medium, including several instructions for enabling a computer device (which can be a personal computer, resource server, or network device, etc.) to execute all or part of the steps of the methods of the various embodiments of this application. The aforementioned non-volatile readable storage media include: USB drives, external hard drives, ROM, RAM, magnetic disks, or optical disks, and various other media that can store program code.

The above is only specific embodiments of this application, and the protection scope of this application is not limited to this. Any variation or substitution that those skilled in the art can easily think of is fallen within the protection scope of this application. Therefore, the protection scope of this application should be defined by the claims.

1. A power conversion circuit, comprising: a voltage conversion ratio control unit, a power conversion unit and a first capacitor, the voltage conversion ratio control unit being formed by connecting a few of capacitors and a few of power switching transistors;
wherein one connection end of the first capacitor is connected to a positive voltage terminal of a power supply circuit, and the other connection end of the first capacitor is connected to a negative voltage terminal of the power supply circuit; a first input connection end of the power conversion unit is connected to the one connection end of the first capacitor, a second input connection end of the power conversion unit is connected to a first input connection end of the voltage conversion ratio control unit; and a second input connection end of the voltage conversion ratio control unit is connected to the other connection end of the first capacitor;
the voltage conversion ratio control unit is configured to change, by controlling the few of power switching transistors to be turned on or off, a connection mode of the few of capacitors, and adjust a voltage value input from the first input connection end and the second input connection end of the voltage conversion ratio control unit, as well as a voltage value input from the first connection end and the second input connection end of the power conversion unit;
the power conversion unit comprises a first output connection end and a second output connection end, the first output connection end and the second output connection end of the power conversion unit are configured to be connected to a load for supplying power to the load.

2. The power conversion circuit according to claim 1, wherein the power conversion unit is a BUCK conversion circuit, a BOOST circuit, or an isolated circuit with a transformer.

3. The power conversion circuit according to claim 1, wherein the power conversion unit comprises a second capacitor, a third capacitor, a first power switching transistor, a second power switching transistor, and an inductor;
wherein one connection end of the second capacitor is connected to the first input connection end of the power conversion unit, and the other connection end of the second capacitor is connected to the second input connection end of the power conversion unit, and the second input connection end of the power conversion unit is connected to the second output connection end of the power conversion unit;
a drain of the first power switching transistor is connected to the one connection end of the second capacitor, a source of the first power switching transistor is connected to one connection end of the inductor, and the other connection end of the inductor is connected to the first output connection end of the power conversion unit;
a drain of the second power switching transistor is connected to the one connection end of the inductor, and a source of the second power switching transistor is connected to the second input connection end of the power conversion unit; and
one connection end of the third capacitor is connected to the first output connection end of the power conversion unit, and the other connection end of the third capacitor is connected to the second output connection end of the power conversion unit.

4. The power conversion circuit according to claim 3, wherein
in response to the first power switching transistor being turned on and the second power switching transistor being turned off, the one connection end of the inductor is connected to the first input connection end of the power conversion unit, and the other connection end of the inductor is connected to the first output connection end of the power conversion unit.

5. The power conversion circuit according to claim 3, wherein
in response to the first power switching transistor being turned off and the second power switching transistor being turned on, the one connection end of the inductor is connected to the second output connection end of the power conversion unit, and the other connection end of the inductor is connected to the first output connection end of the power conversion unit.

6. The power conversion circuit according to claim 3, further comprising a first switching transistor drive control unit, wherein a gate of the first power switching transistor and a gate of the second power switching transistor are connected to the first switching transistor drive control unit.

7. The power conversion circuit according to claim 6, further comprising a first output voltage sampling unit and a first voltage comparison unit, wherein the first voltage comparison unit is connected to the first output voltage sampling unit and the first switching transistor drive control unit respectively;
wherein the first output voltage sampling unit is configured to sample an output voltage output from the first output connection end and the second output connection end of the power conversion unit, and send the output voltage to the first voltage comparison unit;
the first voltage comparison unit is configured to compare the output voltage with a reference voltage, and send a comparison result to the first switching transistor drive control unit;
the first switching transistor drive control unit is configured to control, based on the comparison result, the first power switching transistor and the second power switching transistor to be turned on or off.

8. The power conversion circuit according to claim 6, wherein the first power switching transistor and the second power switching transistor are NMOS transistors;
in response to the gates of the first power switching transistor and the second power switching transistor being provided with a high-level signal by the first switching transistor drive control unit, the first power switching transistor and the second power switching transistor are turned on;
in response to the gates of the first power switching transistor and the second power switching transistor being provided with a low-level signal by the first switching transistor drive control unit, the first power switching transistor and the second power switching transistor are turned off.

9. The power conversion circuit according to claim 6, wherein the first power switching transistor and the second power switching transistor are PMOS transistors;
in response to the gates of the first power switching transistor and the second power switching transistor being provided with a low-level signal by the first switching transistor drive control unit, the first power switching transistor and the second power switching transistor are turned on;
in response to the gates of the first power switching transistor and the second power switching transistor being provided with a high-level signal by the first switching transistor drive control unit, the first power switching transistor and the second power switching transistor are turned off.

10. The power conversion circuit according to claim 1, wherein the few of capacitors comprise a fourth capacitor, a fifth capacitor, a sixth capacitor and a seventh capacitor, and the few of power switching transistors comprise a third power switching transistor, a fourth power switching transistor, a fifth power switching transistor, a sixth power switching transistor, a seventh power switching transistor and an eighth power switching transistor;
wherein one connection end of the fourth capacitor is connected to the first input connection end of the voltage conversion ratio control unit, and the other connection end of the fourth capacitor is connected to the second input connection end of the voltage conversion ratio control unit;
a drain of the third power switching transistor is connected to the one connection end of the fourth capacitor, a source of the third power switching transistor is connected to a drain of the fourth power switching transistor, and a source of the fourth power switching transistor is connected to the other connection end of the fourth capacitor;
one connection end of the fifth capacitor is connected to the source of the third power switching transistor, the other connection end of the fifth capacitor is connected to a source of the fifth power switching transistor and a drain of the sixth power switching transistor, a drain of the fifth power switching transistor is connected to a first voltage adjustment end of the voltage conversion ratio control unit, and a source of the sixth power switching transistor is connected to a second voltage adjustment end of the voltage conversion ratio control unit;
one connection end of the sixth capacitor is connected to the source of the fourth power switching transistor, the other connection end of the sixth capacitor is connected to a source of the seventh power switching transistor and a drain of the eighth power switching transistor, a drain of the seventh power switching transistor is connected to the first voltage adjustment end of the voltage conversion ratio control unit, and a source of the eighth power switching transistor is connected to the second voltage adjustment end of the voltage conversion ratio control unit;
one connection end of the seventh capacitor is connected to the first voltage adjustment end of the voltage conversion ratio control unit, and the other connection end of the seventh capacitor is connected to the second voltage adjustment end of the voltage conversion ratio control unit.

11. The power conversion circuit according to claim 10, wherein
in response to the third power switching transistor, the fifth power switching transistor and the eighth power switching transistor being turned off, and the fourth power switching transistor, the sixth power switching transistor and the seventh power switching transistor being turned on, the one connection end of the fifth capacitor is connected to the one connection end of the sixth capacitor, the other connection end of the fifth capacitor is connected to the other connection end of the seventh capacitor, and the one connection end of the seventh capacitor is connected to the other connection end of the sixth capacitor.

12. The power conversion circuit according to claim 11, wherein
in response to the third power switching transistor, the fifth power switching transistor and the eighth power switching transistor being turned off, and the fourth power switching transistor, the sixth power switching transistor and the seventh power switching transistor being turned on, voltage across the seventh capacitor is equal to a sum of the voltage across of the fifth capacitor and the voltage across the sixth capacitor.

13. The power conversion circuit according to claim 10, wherein
in response to the third power switching transistor, the fifth power switching transistor and the eighth power switching transistor being turned on, and the fourth power switching transistor, the sixth power switching transistor and the seventh power switching transistor being turned off, the one connection end of the fifth capacitor is connected to the first input connection end of the voltage conversion ratio control unit, the other connection end of the fifth capacitor is connected to the one connection end of the seventh capacitor, the other connection end of the seventh capacitor is connected to the other connection end of the sixth capacitor, and the one connection end of the sixth capacitor is connected to the second input connection end of the voltage conversion ratio control unit.

14. The power conversion circuit according to claim 13, wherein
in response to the third power switching transistor, the fifth power switching transistor and the eighth power switching transistor being turned on, and the fourth power switching transistor, the sixth power switching transistor and the seventh power switching transistor being turned off, the voltage across the fourth capacitor is twice of the voltage across the seventh capacitor.

15. The power conversion circuit according to claim 10, further comprising a second switching transistor drive control unit, wherein the gates of the third power switching transistor, the fourth power switching transistor, the fifth power switching transistor, the sixth power switching transistor, the seventh power switching transistor, and the eighth power switching transistor are all connected to the second switching transistor drive control unit.

16. The power conversion circuit according to claim 15, further comprising a second output voltage sampling unit and a second voltage comparison unit, wherein the second voltage comparison unit is connected to the second output voltage sampling unit and the second switching transistor drive control unit respectively;
wherein the second output voltage sampling unit is configured to sample voltage between the first voltage adjustment end and the second voltage adjustment end of the voltage conversion ratio control unit, and send the voltage to the second voltage comparison unit;
the second voltage comparison unit is configured to compare the voltage with a second reference voltage, and send a comparison result to the second switching transistor drive control unit;
the second switching transistor drive control unit is configured to control, based on the comparison result, the third power switching transistor, the fourth power switching transistor, the fifth power switching transistor, the sixth power switching transistor, the seventh power switching transistor, and the eighth power switching transistor to be turned on or off.

17. The power conversion circuit according to claim 15, wherein the third power switching transistor, the fourth power switching transistor, the fifth power switching transistor, the sixth power switching transistor, the seventh power switching transistor, and the eighth power switching transistor are NMOS transistors;
in response to the gates of the third power switching transistor, the fourth power switching transistor, the fifth power switching transistor, the sixth power switching transistor, the seventh power switching transistor, and the eighth power switching transistor being provided with a high-level signal by the second switching transistor drive control unit, the third power switching transistor, the fourth power switching transistor, the fifth power switching transistor, the sixth power switching transistor, the seventh power switching transistor, and the eighth power switching transistor are turned on;
in response to the gates of the third power switching transistor, the fourth power switching transistor, the fifth power switching transistor, the sixth power switching transistor, the seventh power switching transistor, and the eighth power switching transistor being provided with a low-level signal by the second switching transistor drive control unit, the third power switching transistor, the fourth power switching transistor, the fifth power switching transistor, the sixth power switching transistor, the seventh power switching transistor, and the eighth power switching transistor are turned off.

18. The power conversion circuit according to claim 15, wherein the third power switching transistor, the fourth power switching transistor, the fifth power switching transistor, the sixth power switching transistor, the seventh power switching transistor, and the eighth power switching transistor are PMOS transistors;
in response to the gates of the third power switching transistor, the fourth power switching transistor, the fifth power switching transistor, the sixth power switching transistor, the seventh power switching transistor, and the eighth power switching transistor being provided with a low-level signal by the second switching transistor drive control unit, the third power switching transistor, the fourth power switching transistor, the fifth power switching transistor, the sixth power switching transistor, the seventh power switching transistor, and the eighth power switching transistor are turned on;
in response to the gates of the third power switching transistor, the fourth power switching transistor, the fifth power switching transistor, the sixth power switching transistor, the seventh power switching transistor, and the eighth power switching transistor being provided with a high-level signal by the second switching transistor drive control unit, the third power switching transistor, the fourth power switching transistor, the fifth power switching transistor, the sixth power switching transistor, the seventh power switching transistor, and the eighth power switching transistor are turned off.

19. The power conversion circuit according to claim 10, wherein the third power switching transistor, the fifth power switching transistor, and the eighth power switching transistor are turned on or off simultaneously, and the fourth power switching transistor, the sixth power switching transistor, and the seventh power switching transistor are turned on or off simultaneously.

20. A power conversion device, comprising a power conversion circuit, wherein power conversion circuit comprises: a voltage conversion ratio control unit, a power conversion unit and a first capacitor, the voltage conversion ratio control unit being formed by connecting a few of capacitors and a few of power switching transistors;
wherein one connection end of the first capacitor is connected to a positive voltage terminal of a power supply circuit, and the other connection end of the first capacitor is connected to a negative voltage terminal of the power supply circuit; a first input connection end of the power conversion unit is connected to the one connection end of the first capacitor, a second input connection end of the power conversion unit is connected to a first input connection end of the voltage conversion ratio control unit; and a second input connection end of the voltage conversion ratio control unit is connected to the other connection end of the first capacitor;
the voltage conversion ratio control unit is configured to change, by controlling the few of power switching transistors to be turned on or off, a connection mode of the few of capacitors, and adjust a voltage value input from the first input connection end and the second input connection end of the voltage conversion ratio control unit, as well as a voltage value input from the first connection end and the second input connection end of the power conversion unit;
the power conversion unit comprises a first output connection end and a second output connection end, the first output connection end and the second output connection end of the power conversion unit are configured to be connected to a load for supplying power to the load.
